(19) United States
(12) Patent Application Publication
(10) Pub. No.: US 2022/0168829 A1
(43) Pub. Date: Jun. 2, 2022

(54) OFFSET BLADE ATTACHMENT APPARATUS AND METHODS OF USING THE SAME

(71) Applicants: Donald Eaton, Algonquin, IL (US); Randy Joyner, Barrington, IL (US)

(72) Inventors: Donald Eaton, Algonquin, IL (US); Randy Joyner, Barrington, IL (US)

(21) Appl. No.: 17/539,865

(22) Filed: Dec. 1, 2021

Related U.S. Application Data
(60) Provisional application No. 63/119,906, filed on Dec. 1, 2020.

(51) Int. Cl. B23D 49/00

(52) U.S. Cl. CPC B23D 49/007

(57) ABSTRACT

An offset blade attachment apparatus comprises a reciprocating element having a blade offset from a center of a reciprocating saw configured to allow the blade to cut an object without interference from the body of the reciprocating saw. The apparatus comprises the reciprocating element configured to reciprocate adjacent a block element having a handle thereon, the block element rigidly connected to the reciprocating saw via an arm, and the reciprocating element having at least one extended rod engaged to a reciprocating shaft extending from the reciprocating saw and connected through an aperture within the block element. Methods of using the same are further provided.

The present invention claims priority to U.S. Prov. Pat. App. No. 63/119,906, titled “Offset Blade Attachment Apparatus and Methods of Using the Same,” filed Dec. 1, 2020, which is incorporated herein by reference in its entirety.

### TECHNICAL FIELD

The present invention relates to an offset blade attachment apparatus. Specifically, the offset blade attachment apparatus comprises a reciprocating element having a blade offset from a center of a reciprocating saw configured to allow the blade to cut an object without interference from the body of the reciprocating saw. The apparatus comprises the reciprocating element configured to reciprocate adjacent a block element having a handle thereon, the block element rigidly connected to the reciprocating saw via an arm, and the reciprocating element having at least one extended rod engaged to a reciprocating shaft extending from the reciprocating saw and connected through an aperture within the block element. Methods of using the same are further provided.

### BACKGROUND

Reciprocating saws are well known for cutting and sawing objects. The term is commonly applied to a type of saw used in construction and demolition work. This type of saw, also known as a hognose, recip saw or a SAWZALL®, is illustrated in FIG. 1, and has a large blade 4 resembling that of a jigsaw and a body 2 oriented to allow the saw 1 to be used comfortably on vertical surfaces. The typical design of this saw has a foot 6 at the base of the blade 4, like that of a jigsaw. The user typically holds or rests this foot 6 on a surface being cut so that the tendency of the blade 4 to push away from or pull towards the cut as the blade 4 travels through its movement can be countered.

In use, the reciprocating saw is typically held by two hands, the first on a trigger button for activating the reciprocating motion of the saw blade, and a second hand on a grip or body of the saw itself for holding the same steady. As the sawblade reciprocates back and forth along a longitudinal axis of the saw body, the sawblade may engage a surface or an object and cut or saw the same.

The reciprocating saw is good for cutting or sawing objects in locations where there is no interference with other surfaces or objects that may be located nearby or disposed perpendicular or otherwise at other angles to the surface being cut. However, if other objects or surfaces are near the object to be cut, the body of the reciprocating saw can interact with the nearby object or surface preventing precise alignment of the sawblade to the object or surface desired to be cut. A need, therefore, exists for an improved saw blade attachment apparatus for a reciprocating saw. Specifically, a need exists for an improved saw blade attachment apparatus that may cut or saw an object or surface with minimal or no interference of the saw body with nearby objects or surfaces.

Specifically, a user may wish to use a reciprocating saw to cut or saw an object or surface immediately adjacent to another object or surface that may extend therefrom. Thus, an extending saw blade on a typical reciprocating saw may not be able to reach the location of cutting or sawing due to the interference of the other object or surface that is in the way. In such a situation, users may try to bend the saw blade as it reciprocates to attempt to move the body of the reciprocating saw away from and clear from the interfering object or surface. This may be dangerous to a user as it puts stress on the blade, which may cause it to break or shatter. Likewise, achieving a precise cut when attempting to clear an interfering object or surface from the body of the reciprocating saw may be difficult if not impossible. A need, therefore, exists for an improved saw blade attachment apparatus that provides a cut to a surface that is nearby other objects or surfaces. Specifically, a need exists for an improved saw blade attachment apparatus comprising an offset blade that provides clearance for the cut from the body of the reciprocating saw.

Moreover, typical apparatuses that comprise offset blades are often difficult to attach and/or detach from a reciprocating saw, and oftentimes are not robust to provide adequate cutting of objects and/or surfaces as desired. A need, therefore, exists for an improved offset blade attachment apparatus that is easy to attach and detach. Likewise, a need exists for an improved offset blade attachment apparatus that provides a robust cut so that the same may be utilized to cut many different types of objects and/or surfaces.

### SUMMARY OF THE INVENTION

The present invention relates to an offset blade attachment apparatus. Specifically, the offset blade attachment apparatus comprises a reciprocating element having a blade offset from a center of a reciprocating saw configured to allow the blade to cut an object without interference from the body of the reciprocating saw. The apparatus comprises the reciprocating element configured to reciprocate adjacent a block element having a handle thereon, the block element rigidly connected to the reciprocating saw via an arm, and the reciprocating element having at least one extended rod engaged to a reciprocating shaft extending from the reciprocating saw and connected through an aperture within the block element. Methods of using the same are further provided.

To this end, in an embodiment of the present invention, an offset blade attachment apparatus is provided, configured for attachment to a reciprocating saw. The offset blade attachment apparatus comprises a first shaft configured to attach on an end thereof to a reciprocating shaft extending from a reciprocating saw, wherein the first shaft extends through a stationary block and is attached to a reciprocating block, wherein the reciprocating block comprises a surface offset from a longitudinal axis of the reciprocating saw having a blade attached thereto, the stationary block rigidly attached to the reciprocating saw via an arm, the stationary block further comprising a handle extending from a side thereof.

It is, therefore, an advantage and objective of the present invention to provide an improved saw blade attachment apparatus for a reciprocating saw.

Specifically, it is an object and advantage of the present invention to provide an improved saw blade attachment apparatus that may cut an object or surface with minimal or no interference by nearby objects or surfaces.

In addition, it is an object and an advantage of the present invention to provide an improved saw blade attachment apparatus that provides a cut to a surface or object without interference from nearby objects or surfaces.

Specifically, it is an object and advantage of the present invention to provide an improved saw blade attachment apparatus comprising an offset blade that provides clearance for the cut from the body of the reciprocating saw.

Moreover, it is an object and advantage of the present invention to provide an improved offset blade attachment apparatus that is easy to attach and detach.

Likewise, it is an object and advantage of the present invention to provide an improved offset blade attachment apparatus that provides a robust cut so that the same may be utilized to cut many different types of objects and/or surfaces.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a prior art reciprocating saw.

FIG. 2 illustrates a perspective view of an offset blade attachment apparatus attached to a reciprocating saw in an embodiment of the present invention.

FIG. 3 illustrates a perspective view of an offset blade attachment apparatus, without the blade, in an embodiment of the present invention.

FIG. 4 illustrates a reverse perspective view of an offset blade attachment apparatus, without the blade, in an embodiment of the present invention.

### DETAILED DESCRIPTION OF THE PRESENTLY PREFERRED EMBODIMENTS

The present invention relates to an offset blade attachment apparatus. Specifically, the offset blade attachment apparatus comprises a reciprocating element having a blade offset from a center of a reciprocating saw configured to allow the blade to cut an object without interference from the body of the reciprocating saw. The apparatus comprises the reciprocating element configured to reciprocate adjacent a block element having a handle thereon, the block element rigidly connected to the reciprocating saw via an arm, and the reciprocating element having at least one extended rod engaged to a reciprocating shaft extending from the reciprocating saw and connected through an aperture within the block element. Methods of using the same are further provided.

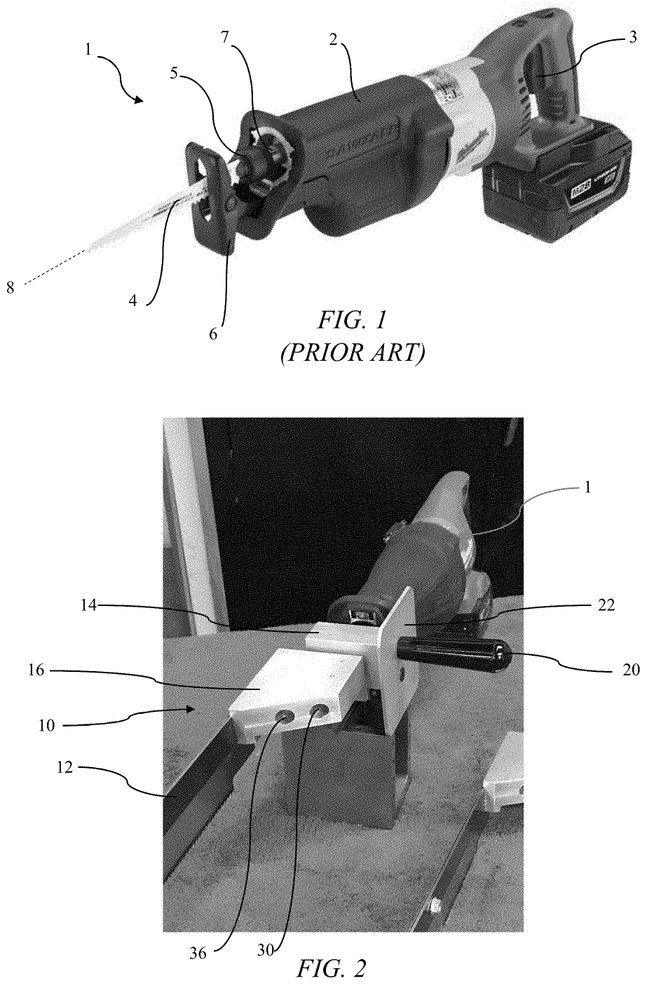

FIG. 1 illustrates a prior art reciprocating saw 1 having a body 2, a trigger 3, and a blade 4 extending from a blade attachment element 5. This type of reciprocating saw is also commonly referred to as a SAWZALL® from Milwaukee Electric Tool Corporation. The blade attachment element 5 allows a blade to be easily and quickly attached and detached as desired by a user thereof. The blade 4 extends through a foot 6 that may extend from the body 2 that may be placed against a surface to be cut so that the tendency of the blade to push away or pull towards the cut as the blade travels can be countered. In use, the blade may reciprocate via a reciprocating shaft 7 extending from the body 2 of the reciprocating saw 1. Thus, a user may hold the body 2 in one hand and may activate the trigger 3 with another hand, thereby activating the same and cutting a surface or object. As illustrated in FIG. 1, the blade 4 typically extends through a center longitudinal axis 8 from the saw 1. As noted herein, this may make it difficult for the blade 4 to cut certain surfaces and/or objects, as the body 2 of the saw 1 may interfere with other interfering objects and/or surfaces.

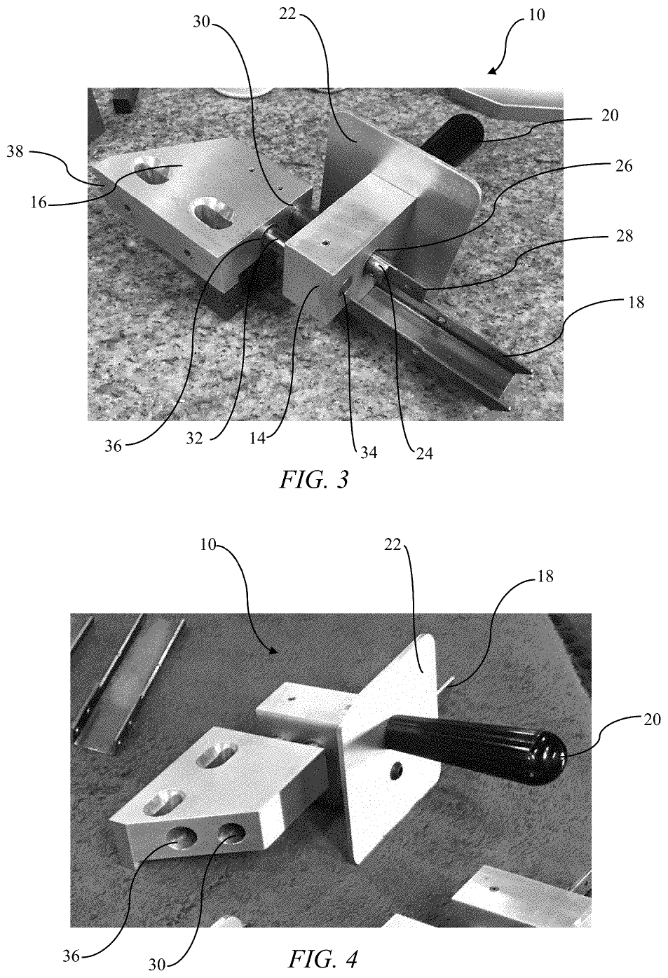

FIGS. 2-4 illustrate an offset blade attachment apparatus 10 in an embodiment of the present invention. The offset blade attachment apparatus 10 may be attached to the reciprocating saw 1 as described below, thereby allowing an offset blade 12 to reciprocate, allowing the offset blade 12 to cut surfaces or objects that may be difficult to cut due to typical presence of the body 2 of the saw 1 that may get in the way of a desired cut. FIG. 2 illustrates the offset blade attachment apparatus 10 attached to the reciprocating saw 1, whereas FIGS. 3 and 4 illustrate the offset blade attachment apparatus 10 without attachment to a saw 1, and also illustrated without an offset blade 12 for simplicity.

The offset blade attachment apparatus 10 may have a stationary block 14 and a reciprocating block 16. The stationary block 14 may be stationary relative to the reciprocating saw 1 due to being rigidly attached to the stationary saw 1. Specifically, the stationary block 14 may be rigidly attached to an arm 18 that may extend from the stationary block and attach to the body 2 of the reciprocating saw 1. Preferably, the arm 18 may attach to the same location that the foot 6 attaches to the saw 1, as illustrated in FIG. 1. Therefore, for use of the offset blade attachment apparatus 10, the foot 6 is removed from the saw 1 to provide clearance for attachment of the offset blade attachment apparatus 10, as described herein. Preferably, the arm 18 is attached to the saw 1 via bolts, screws, pins, or other like connection elements.

The stationary block 14 may further have a handle 20 extending from a side thereof, and a shield 22 disposed between the handle 20 and the stationary block 14 for protecting a user's hand from the offset blade 12 and any debris that may fly from a cut performed thereby. It should be noted that the handle 20 and the shield 22 can be on either side of the stationary block 14, and the invention should not be limited as shown in the figures herein. Indeed, it should be noted that the offset blade attachment apparatus is reversible so that the blade 12 may be disposed on any side of the saw 1, including the left side, the right side, the top side, or the bottom side.

A first shaft or rod 24 may extend through a first passage 26 within the stationary block 14 having an attachment end 28 for attaching to the reciprocating shaft 7 of the saw 1 via the blade attachment element 5. Commonly, the blade attachment element 5 of the saw 1 comprises a threaded attachment compression collar that may tighten around a receiving slot, thereby holding a blade 4, or in the context of the present invention, the attachment end 28 of the first shaft 24 of the offset blade attachment apparatus 10. The first shaft 24 may freely travel through the first passage 26 and extend within a second passage 30 within the reciprocating block 16, as illustrated in FIG. 3. The first shaft 24 may be attached or otherwise affixed within the second passage 30 of the reciprocating block 16 via one or more set screws, although the shaft 24 may be attached to the reciprocating block 16 in any manner and should not be limited as described herein. Therefore, as the reciprocating shaft 7 of the saw 1 reciprocates, the first shaft 24 may travel therewith through the stationary block 14 that is rigidly attached to the saw 1 via the arm 18. Because the first shaft 24 is connected to the reciprocating block 16 by being attached within the second passage 30, the first shaft 24 may impart reciprocating motion to the reciprocating block 16.

A second shaft or rod 32 may extend from the stationary block 14 and may be rigidly attached or otherwise connected to the stationary block 14 within third passage 34, and may extend freely within fourth passage 36 within reciprocating block 16 thereby providing a supporting element that may maintain the reciprocating block 16 in its proper orientation. Alternatively, the second shaft or rod 32 may be attached to the reciprocating block 16 and freely pass through third passage 34 within stationary block 14, as either manner will achieve the desired purpose of maintaining stability and orientation of the reciprocating block 16 relative to the stationary block 14.

Blade 12 may be attached to a blade attachment surface 38 on the side of reciprocating block 16 thereby extending at a position offset from the center longitudinal axis 8 of the saw 1. The blade 12 may be any type of blade providing the ability to cut an object or a surface and should not be limited as described herein. The blade attachment surface 38 may be any distance from the center longitudinal axis 8 as desired; however, it should be noted that the distance of the blade attachment surface from the center longitudinal axis 8 may preferably be the same distance or more as the distance from the center longitudinal axis 8 to the side of the body 2 of the saw 1 so that the blade 12 may clear the body 2 when cutting a surface or object in which the body would otherwise interfere but for the offset blade attachment apparatus 10.

The blade 12 may be rigidly attached or otherwise connected to the blade attachment surface 38 so that the same may reciprocate with the reciprocating block 16 as the reciprocating shaft 7 reciprocates through the first shaft 24. Specifically, the blade 12 may be attached to the surface 38 via screws, bolts, pins, adhesive, or any other connection means apparent to one of ordinary skill in the art.

Thus, a user of the saw 1 having the offset blade attachment apparatus 10 connected thereto may attach the offset blade attachment apparatus 10 by removing the foot 6 and attaching arm 18 in its place, while also attaching the reciprocating shaft 7 to the connecting end 28 of the first shaft 26 via the compression collar 5. If the offset blade 12 is desired on the right side of the body 2 of the saw 1, then the apparatus 10 is attached to the saw 1 in an orientation such that the blade 12 is offset to the right of the saw 1; likewise, if the offset blade 12 is desired on the left side of the body 2 of the saw 1, then the apparatus 10 is attached to the saw 1 in an orientation such that the blade 12 is offset to the left of the saw 1. The offset blade 12 may also be oriented to be offset to a top side and/or a bottom side by having the location of the attachment surface 38 on the reciprocating block 16 to be on the top side and/or the bottom side, respectively, of the reciprocating block 16.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1. An offset blade attachment apparatus configured for attachment to a reciprocating saw comprising:
a first shaft configured to attach on an end thereof to a reciprocating shaft extending from a reciprocating saw, wherein the first shaft extends through a stationary block and is attached to a reciprocating block, wherein the reciprocating block comprises a surface offset from a longitudinal axis of the reciprocating saw having a blade attached thereto, the stationary block rigidly attached to the reciprocating saw via an arm, the stationary block further comprising a handle extending from a side thereof.
